(19) United States
(12) Patent Application Publication
(10) Pub. No.: US 2010/0308546 A1
(43) Pub. Date: Dec. 9, 2010

(54) Device for Holding Tools on Machine Tools

(75) Inventors: Klaus Maier, Offenburg (DE); Karlheinz Jansen, Schutterwald (DE)

Correspondence Address: GUDRUN E. HUCKETT DRAUDT, SCHUBERTSTR. 15A, WUPPERTAL, 42289, DE

(73) Assignee: WTO WERKZEUG-EINRICHTUNGEN GMBH, Ohlsbach (DE)

(21) Appl. No.: 12/675,444

(22) PCT Filed: Sep. 3, 2008
(86) PCT No.: PCT/DE2008/001473

§ 371 Date: Aug. 21, 2010

(30) Foreign Application Priority Data
Sep. 11, 2007 (DE) 10 2007 043 285.4

(51) Int. Cl. B23B 31/107

(52) U.S. Cl. 279/83

(57) ABSTRACT

The invention relates to a device for holding tools (13) on machine tools, comprising a tool receptacle (1) and a tool holder (6). Clamping elements (4) are used for fixing the two parts. According to the invention, the device is configured in such a way that both the tool holder (6) of a first type and the tool holder (6) of a second type can be adapted. The tool holders (6) of the first type meet the HSK standard while the tool holders (6) of the second type, for the purpose of shortening the length, do not have any receptacle (11) for a clamping system as it is required for tool holders (6) of the first type.

The invention concerns a device for holding tools on machine tools.

For machining workpieces, stationary or rotating tools are used. They are secured by means of appropriate holding devices on the machine tool. These tools may be drills, milling tools, saw blades or other machining tools that are generally provided and suitable for machining workpieces.

Such devices for holding tools on machine tools comprise toolholder receptacles that may be, for example, a spindle or a part of a spindle or a tool holder receptacle that does not rotate. These toolholder receptacles have at the end face, viewed in axial direction, a conical receptacle. Moreover, an actual toolholder is provided that receives the tool. This toolholder has at its rear a cone that is inserted into the axial conical receptacle of the toolholder receptacle and is secured therein.

A special type of such a device for holding tools on machine tools is the system according to the so-called HSK standard based on ISO 12164 and DIN 69893. In this system, clamping systems or clamping mechanisms for damping toolholders are provided that engage centrally from behind. They achieve by means of a mechanism and an undercut provided on the toolholder an axial clamping action between the toolholder and the toolholder receptacle. This damping system engages a receptacle at the rear in the form of a recess of the toolholder. Clamping of the damping system is realized either in that the toolholder has through bores arranged laterally in the conical area through which an appropriate actuation tool for the clamping system can be inserted or, on the other hand, in that the damping system is actuated by an axial movement engaging from behind. In both cases, the clamping system engages an undercut formed on the toolholder. As a result of the geometry of the interface between the toolholder receptacle and the toolholder, a contact between the two conical shapes as well as contact between corresponding planar surface is achieved. The toolholder is therefore aligned in axial and radial directions without play.

The disadvantage of these integrated clamping systems is that the central inner area of the toolholder with the receptacle for the damping system cannot be utilized. This is so because the central inner area is provided exclusively for the clamping system. This causes large total tool lengths comprised of the toolholder receptacle and toolholder. These length are undesirable on compact machines and turning lathes for space reasons and because of the resulting bending moments of machining forces and large lever arm.

to This known system according to the so-called HSK standard is also realized in connection with toolholders whose cone across the entire axial length has no round cross-section but is formed as a rounded polygon.

The known systems according to the so-called HSK standard as well as the modified embodiments with rounded polygons are therefore referred to in the following as “toolholders of the first kind”.

The object of the invention is to provide a device for holding tools on machine tools that is universally applicable for different toolholders.

The technical solution is characterized by the features of claim 1.

In this way a universally suitable device for holding tools in machine tools is provided in which not only toolholders according to the so-called HSK standard but also toolholders of a second kind which in principle have no receptacle for a clamping system of the toolholder receptacle of the first kind can be adapted in a compatible way. Accordingly, the inner area of the toolholder is available again, i.e. at a location where the clamping system was positioned before. In this way, this adapter can be used with special toolholders that are not standardized according to HSK. At the same time, the full exchangeability of the toolholders of the first kind remains intact so that these toolholder of the first kind can still be used. Accordingly, the toolholder receptacle in its geometry corresponds to that designed for the toolholders of the first kind (i.e., according to the so-called HSK standard). The toolholder receptacle can thus receive the toolholders of the first kind as well as adapted, short toolholders of the second kind in a compatible way. For improving the axial clamping forces, especially adapted recesses are provided in the circumferential wall surface of the cone of the toolholder. In this connection, preferably the clamping element and the recess are configured such that during the inward movement of the clamping element the toolholder can be axially pressed into the toolholder receptacle. The recesses may be blind bores, through bores, but also circumferentially extending grooves.

A further embodiment is proposed in claim 2 in a first variant. The basic principle resides in that for the adaptation of a toolholder of the first kind (i.e., according to the so-called HSK standard) the lateral bores in the conical area that are provided for accessibility to the manual damping systems are utilized in order to generate the axial clamping forces by means of lateral damping elements. This means that for these toolholders of the first kind the clamping elements engage the open area of the through bores of the toolholder and in this way the axial clamping forces are generated. This embodiment however also allows to adapt toolholders of the second kind.

An alternative to this first variant is proposed in claim 3. Here the basic idea resides in that the existing through bores in the toolholder of the first kind are not used but instead additional recesses are provided where the damping elements engage. This variant has the advantage that by an appropriate shaping of the recesses optimal geometric conditions can be provided.

A further embodiment is proposed in claim 4. The basic idea resides in that the already existing through bores in the toolholder receptacle are embodied for toolholders of the first kinds as clamping bores, in particular as threaded bores for damping screws. These clamping bores serve then for receiving the clamping elements, in particular the aforementioned clamping screws. Nonetheless, these clamping bores are still suitable for passing through an appropriate actuating tool for the clamping system for toolholders of the first kind.

An alternative to this is proposed in claim 5. The basic idea resides in that for the clamping elements not the through bores existing anyway in the toolholder receptacle are to be used but the toolholder receptacle is provided with additional separate clamping bores. This has the advantage that these clamping bores are optimally adaptable to the desired specifications.

A further embodiment is proposed in claim 6. In this way the fixation of the toolholder in the toolholder receptacle can be very flexibly designed. This is so because the fixation system is independent of which orientation the clamping bore of the clamping element has in the toolholder receptacle. This is so because the front end of the clamping element is securable always in one and the same receptacle which is formed in the toolholder. This means in practical application that for a toolholder receptacle with a different orientation for the clamping elements no corresponding toolholder must be made available. Instead, one and the same toolholder can be used for toolholder receptacles with different orientations of the clamping bores.

A first variant in the arrangement of the clamping elements provides according to the embodiment of claim 7 that the axis of the clamping bore is positioned perpendicularly to the tool axis. In this way, a radial arrangement of the clamping elements is realized.

As an alternative, according to claim 8 the clamping elements can also be oriented at a slant, preferably at a slant from the front. With the slight slant of the clamping elements even more space is saved so that by the shortening in axial direction the total length is further shortened. As a result of the relatively minimal slant a substantially unimpaired access to the damping elements is still possible. For a suitable selection of the slant angle (e.g. 30° to the radial direction) also standard screws instead of special screws can be used as clamping elements.

The embodiment according to claim 9 concerns a follower element in the toolholder receptacle. This is so because diverse variants exist for toolholders of the first kind. One variant is provided for high-speed machines and has no tongue and groove system at the end of the cone of the toolholder for positive-locking entrainment of the toolholder in the toolholder receptacle. With a removable follower element, for example, in the form of a follower ring or in the form of follower bolts, it is now possible to receive all variants of the toolholders when the follower element is demounted. When the follower element is mounted, the additional positive entrainment and mounting orientation can be utilized. In principle, generally all variants of toolholders can be operated without the tongue and groove system. With a special adaptation of clamping element and lateral bore, a play-free torque transmission between the clamping element and the cone of the toolholder is possible by means of the resulting positive locking action.

The embodiment according to claim 10 with an additional access bore in the toolholder receptacle for toolholders with lateral clamping element for cutting tools has the advantage that very short toolholders for cutting tools with lateral clamping surface can be realized. This has the advantage that the toolholder must not always be removed in order to exchange the cutting tool.

The further embodiment in accordance with claim 11 has the advantage that in this way the axial length of the toolholder is reduced to a minimum.

As a result of the self-locking action and also as a result of sticking caused by cooling agent, it may happen during exchange of the toolholders that they will not automatically detach from the conical receptacle of the toolholder receptacle. By providing at least one groove according to the embodiment of claim 12, for example, by means of an actuating wrench for clamping/releasing the clamping elements a release process can be initiated after releasing the clamping elements. As a result of the spacing of approximately the wrench width of a hexagon wrench and rotation of this hexagon wrench to the width across corners a satisfactory release stroke can be achieved.

For realizing the shortest possible tool receptacles it may be expedient, according to the embodiment of claim 13, to embody the stop screw for length adjustment not as a component of the toolholder but as a component of the toolholder receptacle. This is primarily expedient when the toolholder is not exchanged for each cutting tool change but stays in the toolholder receptacle and the operator directly exchanges the cutting tool.

As a result of the overlap of the cone of the chuck with the outer cone of the toolholder, a geometrical change of the outer cone of the toolholder may result during clamping of the chuck receptacle. In order to counteract the resulting unavoidable interface deviations, according to the embodiment of claim 14 the toolholder is formed with a special radial hollow ground shape. Alternatively, the inner cone of the toolholder receptacle can also be provided with a radial hollow-ground shape. This means that in the clamped state of the chuck receptacle a defined receiving action in the form of a double cone centering action is provided.

The embodiment according to claim 15 proposes different cross-sectional shapes of the cone of the toolholder. In addition to the round cone according to the so-called HSK standard, there is also a cone with a non-round cross-section in the form of a conical polygon with edges that are however rounded. The radial receiving action is realized by means of the conical polygon and the axial receiving action additionally by a planar surface. Additional elements in the form of tongue and groove for torque transmission are not required as a result of the polygon shape. Clamping of this interface is also known to be provided by a central clamping system of the type known from the HSK interface. Alternatively, clamping can also be achieved from behind by a central screw. In both cases, the inner area of the interface is however occupied and cannot be used. However, there are lateral bores provided here which however serve for supplying the cooling medium. When using such a toolholder with conical polygon, the clamping elements are designed such that primarily an axial clamping force is generated in order to bring the inner and outer polygons as well as the planar surfaces in contact with one another and to generate pretension. Since however the interior of the interface between the toolholder and the toolholder receptacle is freely available, all of the afore described advantages are realized. For example, it is furthermore possible to provide the no longer required inner clamping area with a cooling medium tube and in this way provide optimal transfer of cooling medium from the toolholder receptacle to the toolholder without the cross-section suddenly widening and therefore impairing the cooling action.

In a first variant, according to the embodiment of claim 16, the clamping bores can be embodied as threaded bores and the clamping elements as clamping screws. These are conventional possibilities of fixation of the toolholder in the toolholder receptacle.

Preferably, in this connection according to the embodiment of claim 17 the clamping screws are provided at the front with a clamping cone. The recesses in the circumferential wall surface of the toolholder are embodied in a matching shape with an inner cone. In this way, an axial movement of the toolholder in the toolholder receptacle during the clamping process is possible in a simple technical way.

An alternative to the clamping cone is provided according to claim 18 in that the clamping screws load at the front end a separate pressure member. This pressure member engages, in turn, the recess in the toolholder.

As an alternative to the clamping screws the clamping elements in a second variant according to the embodiment of claim 19 can be provided on an adjusting element that is correlated with the toolholder receptacle. In this connection, the clamping elements are movable substantially radially into the clamping bore by an adjusting movement of the adjusting element. Different technical realizations of the adjusting element are possible in this connection. For example, the adjusting element can be embodied as a clamping lever, an axially adjustable collar-like clamping ring, or a rotatable clamping ring.

The features of the dependant claims represent each their own inventions independent of the subject matter of the independent claim.

Embodiments of a device according to the invention for holding tools in machine tools will be explained in the following with the aid of the drawings. The drawings show in:

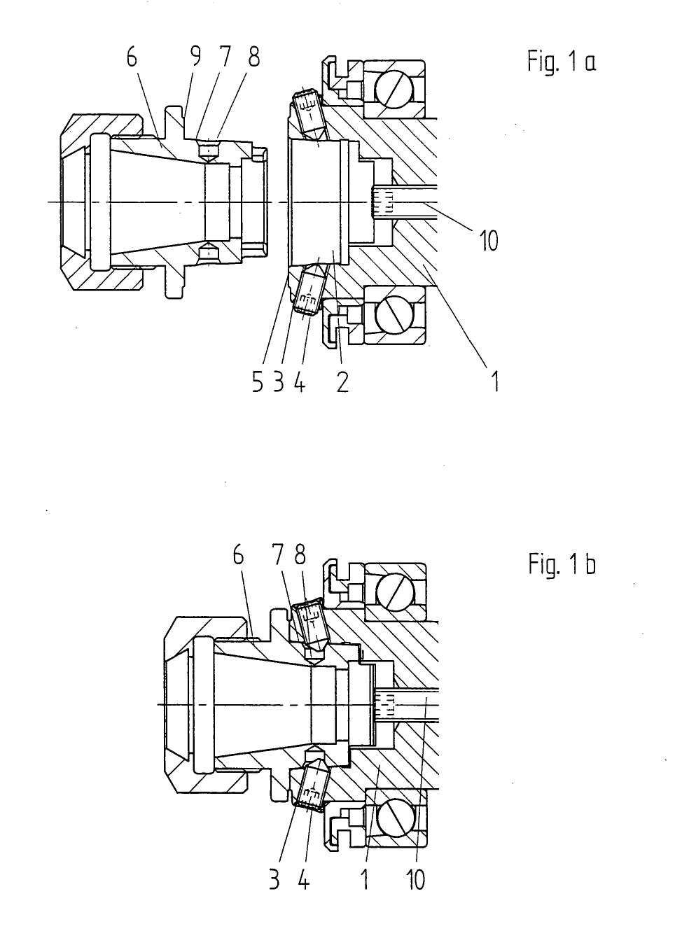

FIG. 1a a first embodiment before insertion of a toolholder of the second kind into the toolholder receptacle;

FIG. 1b an illustration in accordance with FIG. 1a but after insertion of the toolholder and tightening of the threaded screws;

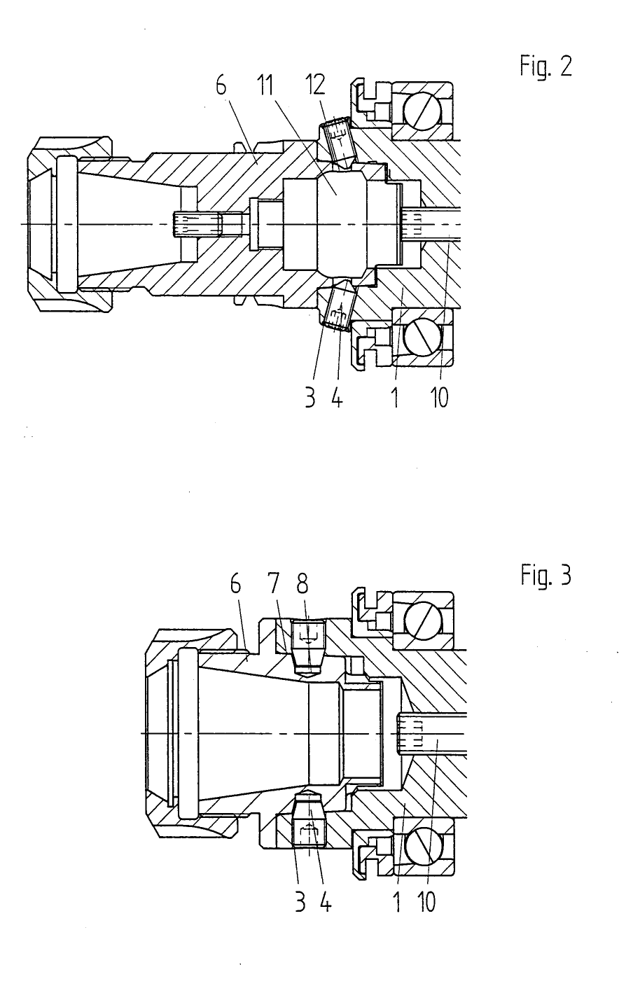

FIG. 2 the same toolholder receptacle as in FIGS. 1a and 1b but with a toolholder of the first kind;

FIG. 3 an illustration according to FIG. 1b but with a modified toolholder in which the clamping elements are screwed in exactly radially;

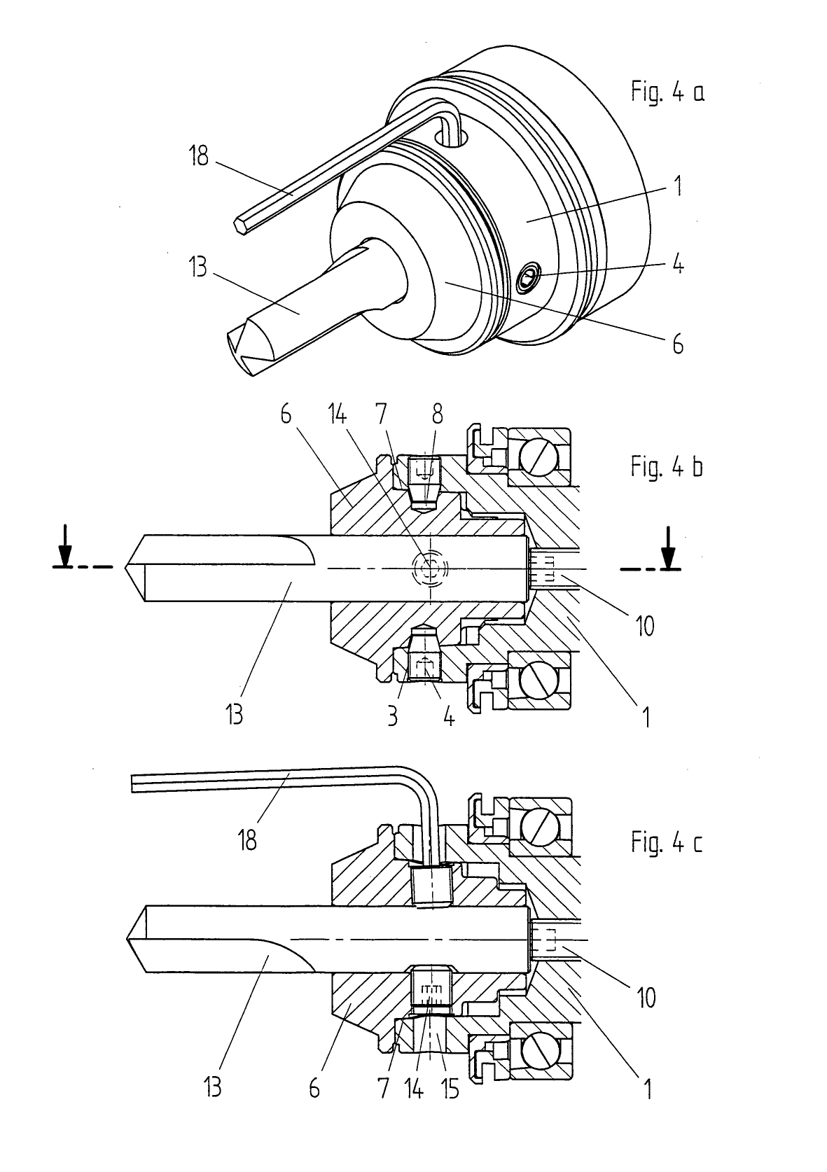

FIG. 4a a perspective illustration of the toolholder receptacle with toolholder;

FIGS. 4b and 4c different longitudinal section illustrations of the system in FIG. 4a wherein the section planes are rotated by 90°;

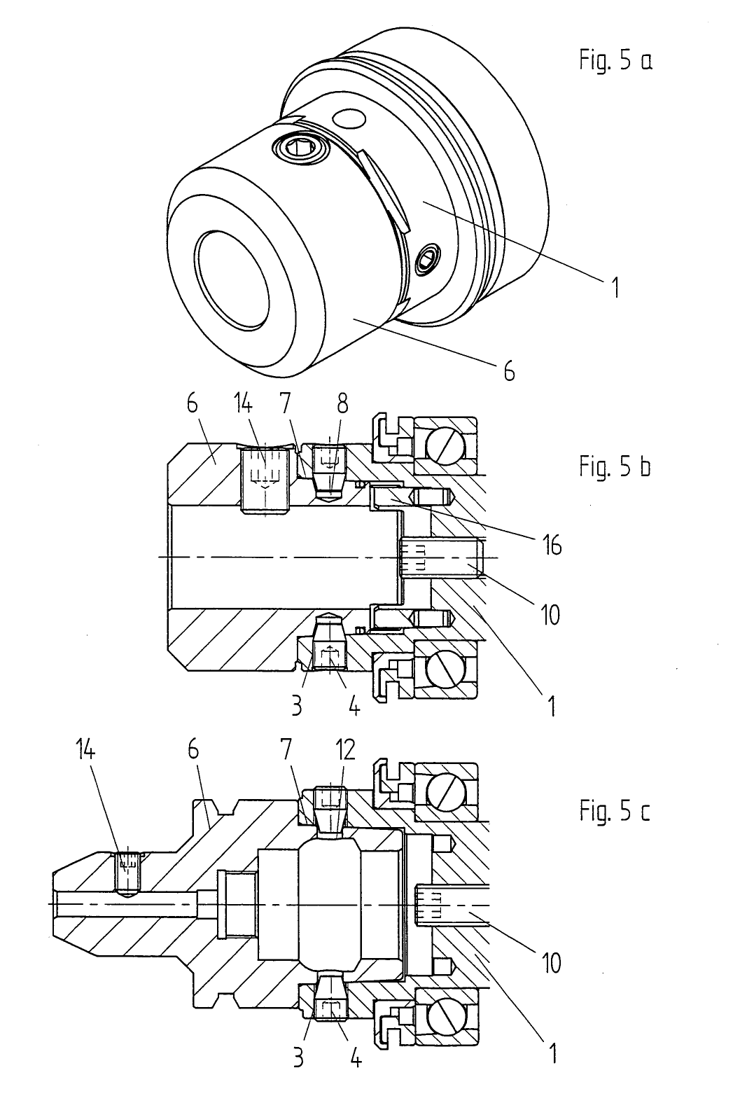

FIG. 5a a perspective view of the toolholder receptacle of the toolholder with a different machining tool receptacle;

FIG. 5b a longitudinal section of the system in FIG. 5 a with a follower element;

FIG. 5c a modified embodiment to FIG. 5b without follower element;

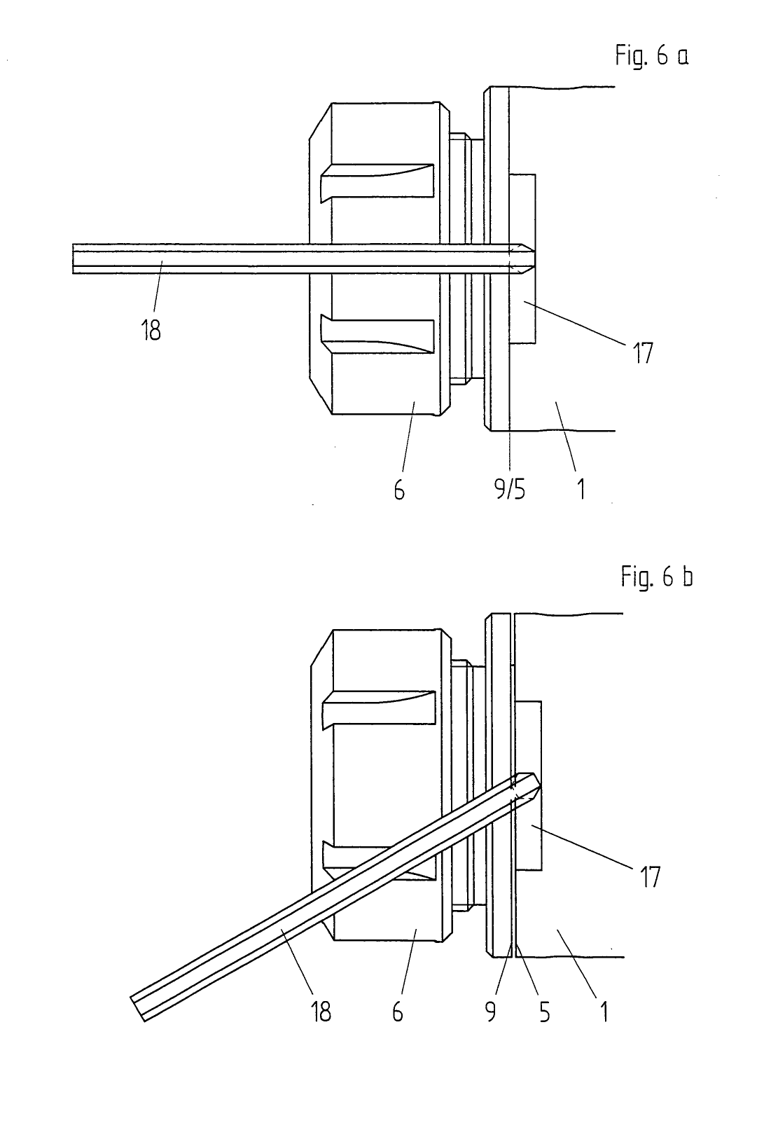

FIGS. 6a and 6b a device for releasing the toolholder from the toolholder receptacle;

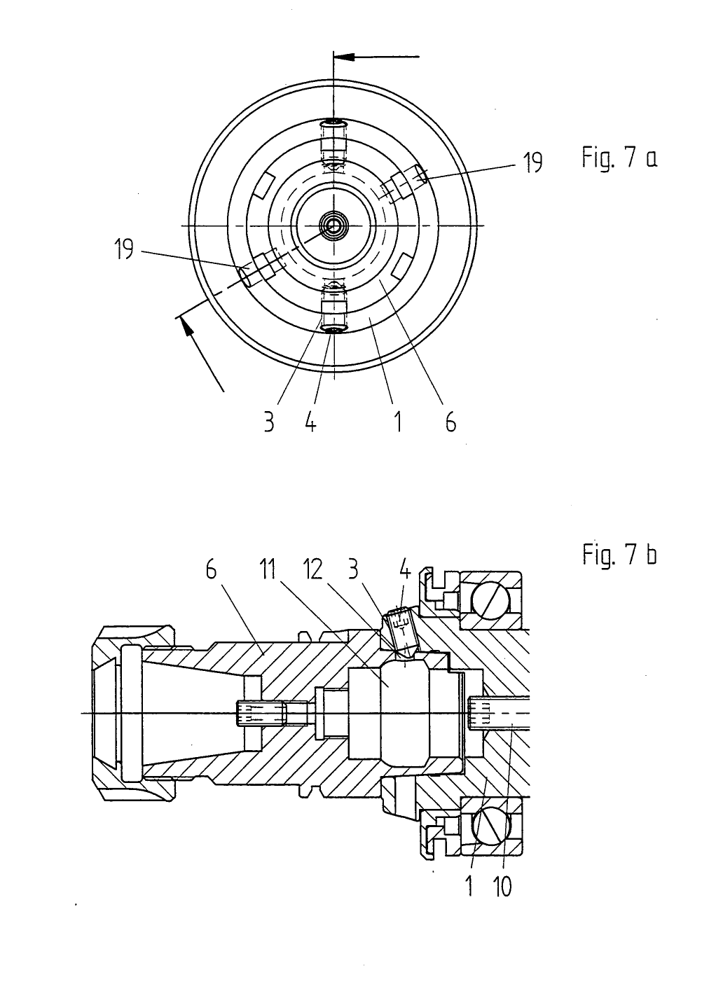

FIG. 7a a plan view of a further embodiment;

FIG. 7b a longitudinal section of the embodiment of FIG. 7a along the illustrated section plane;

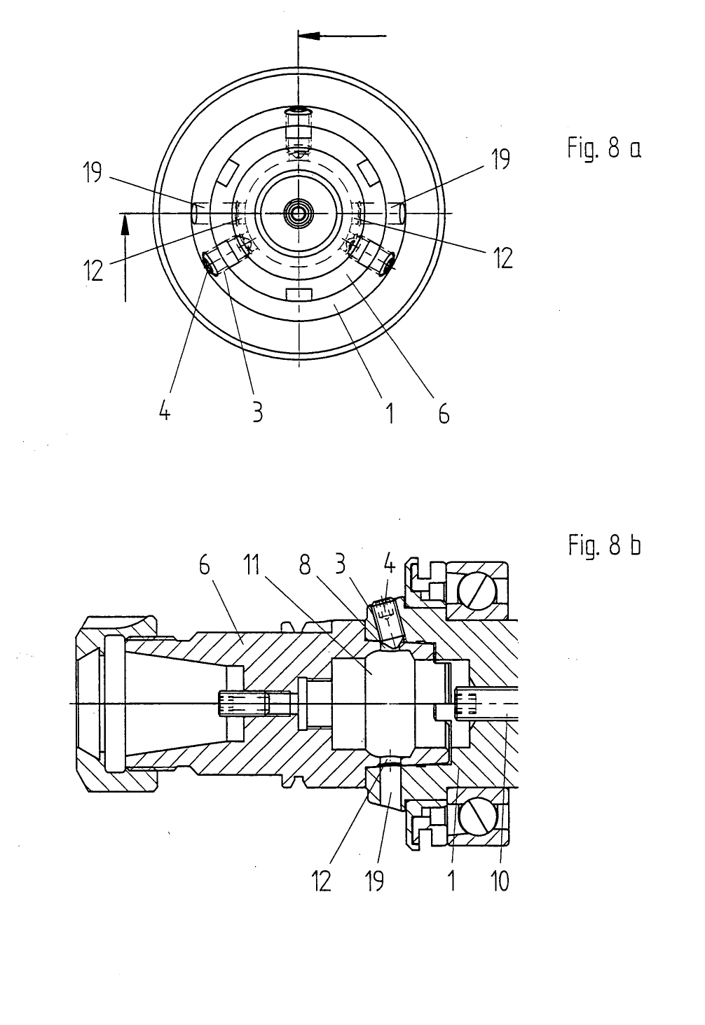

FIG. 8a a plan view onto a further embodiment;

FIG. 8b a longitudinal section of the embodiment in FIG. 8a along the illustrated section plane;

FIG. 9 a longitudinal section of a further embodiment in which the clamping screw acts on a pressure member;

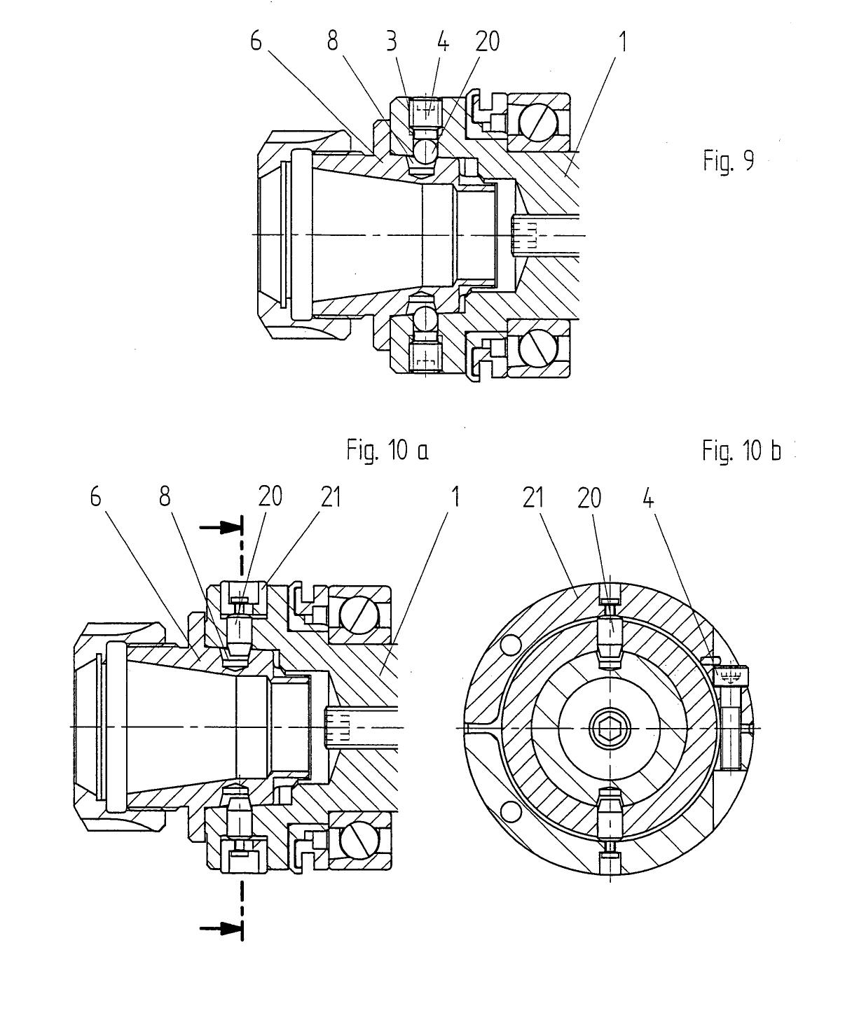

FIG. 10a a further embodiment in longitudinal section in which the clamping elements are adjustable radially by clamping levers;

FIG. 10b a section along the dash-dotted line in FIG. 10a;

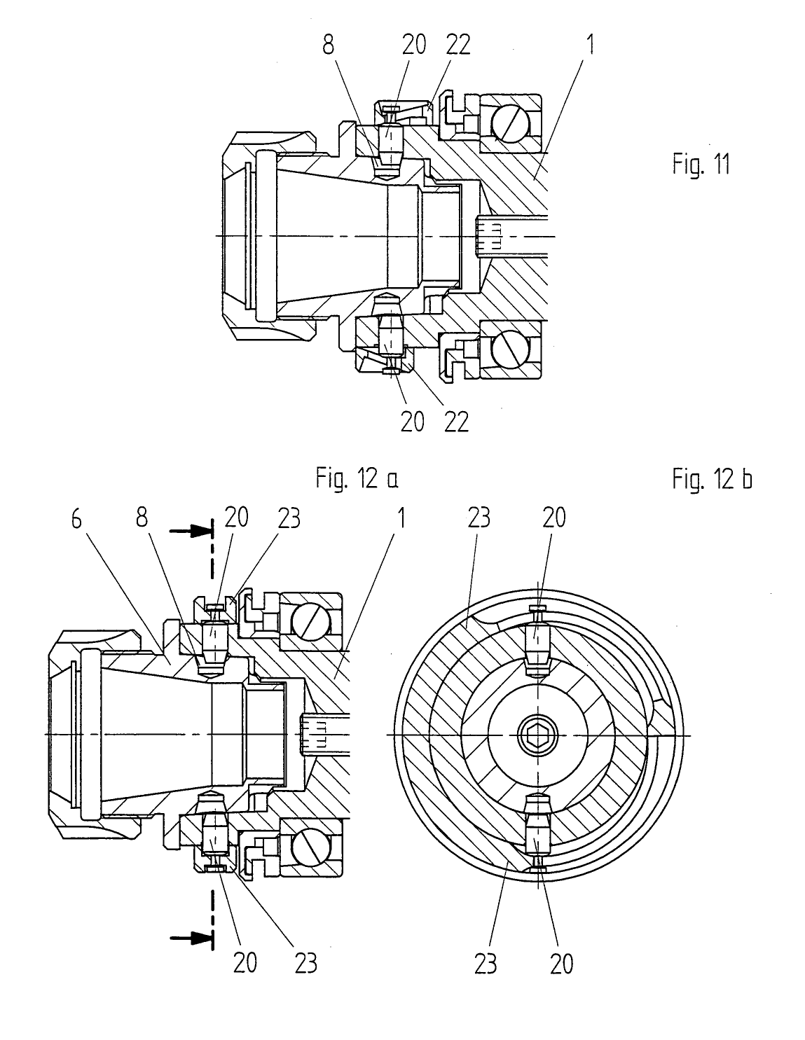

FIG. 11 a further embodiment in longitudinal section in which as an adjusting element for the clamping element an axially movable clamping ring is provided;

FIG. 12a a longitudinal section of a further embodiment using a rotatable clamping ring;

FIG. 12b a section illustration according to dash-dotted line in FIG. 12a.

FIG. 1a shows a toolholder receptacle 1 at the front end of a spindle. This toolholder receptacle 1 has at the end face a conical receptacle 2. Into this receptacle clamping bores 3 in the form of threaded bores open that extend at a slant from the front toward the receptacle and receive clamping elements 4 in the form of damping screws. Moreover, at the end face a planar surface 5 is provided.

Moreover, the toolholder 6 is illustrated. It has a cone 7 that matches the conical receptacle of the toolholder receptacle 1. In the area of the cone 7 the wall surface has recesses 8. They match the clamping elements 4 of the toolholder receptacle 1. Moreover, the toolholder 6 has a planar surface 9 matching the planar surface 5. Finally, as a limitation for the tool a stop screw 10 is provided in the toolholder receptacle 1.

The function is as follows

The toolholder 6 is inserted with its cone 7 into the conical receptacle 2 of the toolholder receptacle 1. Subsequently, the clamping elements 4 are screwed in inwardly so that they will come to rest in the recesses 8. The interaction between the clamping elements 4 and the recess 8 is such that the toolholder 6 is moved into the interior of the conical receptacle 2 of the toolholder receptacle 1 (this means to the right in the drawing).

The variant in FIG. 2 is based on an identical toolholder receptacle 1 as illustrated in FIGS. 1a and 1b. The difference resides in the toolholder 6. In concrete, the difference resides in that the toolholder 6 has at the rear a receptacle 11. This receptacle 11 may receive a clamping system, not illustrated, of the toolholder receptacle 1 that is capable of clamping the toolholder with an appropriately designed toolholder receptacle such that the clamping system engages the undercuts. The actuation of this clamping system can be realized either by an axial movement originating from the toolholder receptacle or by a lateral insertable actuating tool. For this purpose, the toolholder 6 in the area of the cone 7 has through bores 12.

The fixation of this toolholder 6 in the conical receptacle 2 of the toolholder receptacle 1 is realized in that the clamping elements 4 of the toolholder receptacle 1 engage these through bores 12 so that as a result of the formation and orientation of the acting counter surfaces the toolholder 6 is forced into the interior of the conical receptacle 2 of the toolholder receptacle 1.

In this way, the toolholder 6 as illustrated in FIG. 2 can be used in the end in the same way as the toolholder 6 illustrated in FIGS. 1a and 1b.

The embodiment in FIG. 3 is based on the basic principle of the configuration of toolholder 6 as illustrated in FIGS. 1a and 1b. The difference resides in that here the clamping elements 4 are not oriented at a slant from the front to the interior but radially.

In other respects, the recesses 8 in the toolholder 6 of FIGS. 1a and 1b as well as FIG. 3 are designed such that in interaction with the clamping elements 4 they can be screwed in either precisely radially or at a slant from the front.

FIGS. 4a to 4c show a tool 13 as it is secured in the toolholder 6. For this purpose, clamping screws 14 are provided in the toolholder 6. They are accessible by means of access bores 15 in the outer wall surface of the toolholder receptacle 1. For this purpose, an actuating tool 18 is provided. Moreover, it can be seen that the tool 13 rests against the stop screw 10.

FIGS. 5a and 5b shows the toolholder receptacle 1 that has a releasable follower element 16 at the bottom of the conical receptacle 2. It serves as a positive-locking tongue and groove connection between the toolholder 6 and the toolholder receptacle 1. Accordingly, the grooves at the end of the (HSK) cone 7 are utilized in connection with the follower element 16.

FIG. 5c shows the system with identical toolholder receptacle 1 with demounted follower element 16. This is so because this (HSK) cone 7 has no grooves at the end.

FIG. 6a shows that in the area of the planar surfaces 5, 9 between the toolholder receptacle 1 and the toolholder 6 a circumferential slot 17 is located. In order to be better able to detach the toolholder 6 from the toolholder receptacle 1 in case of a tool exchange, an actuation tool 18 in the form of an external hexagon wrench can be inserted in this circumferential slot. The width of this circumferential slot 17 is such that by rotation of the actuating tool 18 the toolholder receptacle 1 and the toolholder 6 are pressed apart.

FIGS. 7a and 7b show an HSK interface with a toolholder 6 standardized according to DIN standard. In this embodiment, the clamping bores 3 for the clamping elements 4 are formed separate from the bores 19 as provided in the toolholder receptacle 1 in order to be able to push through the actuating tool for actuation of the clamping system. FIG. 7a shows that these clamping bores 3 are arranged with their clamping elements 4 in 12 o'clock as well as 6 o'clock position while the bores 19 in the toolholder receptacle 1 are in the 2 o'clock and 8 o'clock position, respectively. In this embodiment, the clamping elements 4 also engage the through bores 12 of the toolholder 6. The embodiment in FIGS. 8a and 8b (also an HSK interface with toolholder 6 standardized according to DIN standard) does not use the through bores 12 that are formed in the toolholder 6 for the clamping elements 4 but, instead, additionally recesses 8 in the conical wall surface of the toolholder 6 are provided. The special recesses 8 are arranged at an angle of 0°, 120°, and 240°. The through bores 12 required for the HSK clamping system are located on a horizontal axis (9 o'clock as well as 3 o'clock position). Other angles are, of course, possible also.

Because of the partial use or the non-use of the existing bores, it is possible to further optimize clamping by means of the clamping elements 4 by changing the geometry and position of the clamping bore 3 and recess 8. For example, larger clamping bores 3 and clamping elements 4 can be employed that then cannot interacting anymore with the existing bores/recesses. Moreover, a modified position of the bores in axial and/or radial direction (optionally not displaced by 180° but by a different angle) is possible. Also, more than three bores can be provided.

While up to now as clamping bores 3 threaded bores and as clamping elements 4 clamping screws with clamping cone have been provided, in the following embodiments the clamping elements and in particular their radial adjustability are designed differently.

In the embodiment of FIG. 9 the damping element 4 is also embodied as a clamping screw but without damping cone. Instead, a pressure member 20 is provided that engages the recess 8. By screwing in this clamping screw that forms the clamping element 4, the pressure member 20 is moved radially inwardly and engages the recess 8 such that the toolholder 6 is pressed into the toolholder receptacle 1.

In the embodiment in FIGS. 10a and 10b the two clamping elements are formed as to pressure members 20 in connection with damping levers 21. The clamping levers 21 are formed as partial rings that are supported in the area of one end pivotably relative to an axis that is parallel to the tool axis. In these clamping levers 21 the pressure members 20 are supported. By inward movement of the clamping levers 21 by means of the clamping elements 4 in the form of a screw the pressure members 20 are moved radially inwardly so that they press the toolholder 6 into the toolholder receptacle 1 by engaging the recesses 8.

The embodiment of FIG. 11 is based also on pressure members 20 that engage matching recesses 8 of the toolholder 6. In this embodiment, however, the pressure members 20 are arranged on a coaxial damping ring 22. In this clamping ring 22 the pressure members 20 are guided by a slanted guide in such a way that upon movement of the clamping ring 22, in the drawing to the right, the damping position (in FIG. 11 at the top) and, in the drawing to the left, the released position (in FIG. 11 at the bottom) of the pressure members 20 is adjusted.

The embodiment of FIGS. 12a and 12b finally also employs pressure members 20 as well as a clamping ring 23. The latter is however rotatably supported on the toolholder receptacle 1 such that by an appropriate guiding action in the circumferential wall area of the clamping ring 23 the pressure members 20 are either moved radially inwardly (in FIG. 12a to the top) into the clamping position or radially outwardly (in FIG. 12a to the bottom) into the release position.

### LIST OF REFERENCE NUMERALS

1 toolholder receptacle
2 conical receptacle
3 clamping bore
4 clamping element
5 planar surface
6 toolholder
7 cone
8 recess
9 planar surface
10 stop screw
11 receptacle
12 through bore
13 tool
14 clamping element
15 access bore
16 follower element
17 circumferential slot
18 actuating tool
19 bore
20 pressure member
21 clamping lever
22 clamping ring
23 clamping ring

What is claimed is:

1.-19. (canceled)

20. A device for holding tools on machine tools, the device comprising:
a toolholder receptacle having at an end face an axial conical receptacle;
a toolholder that is adapted to hold a tool, wherein the toolholder has a cone at a rear thereof for disposing the toolholder in the conical receptacle of the toolholder receptacle;
clamping elements inserted into lateral clamping bores of the toolholder receptacle for fixation of the cone in the conical receptacle, wherein the clamping elements engage matching recesses provided on a circumferential wall surface of the cone;
wherein the device is designed such that, alternatively, toolholders of a first kind and toolholders of a second kind can be secured in the toolholder receptacle;
wherein the toolholder of the first kind is provided at the rear in the cone with an axial receptacle for a clamping system of the toolholder receptacle and have through bores laterally arranged in the cone through which through bores the clamping system is accessible by an actuating tool and which through bores are not designed and embodied such that fixation devices engage laterally the cone, wherein for the fixation exclusively recesses are provided that are already existing laterally on the cone or that are provided thereat as counter elements for the clamping elements; and
wherein the toolholders of the second kind at the rear has no axial receptacle in the cone for a clamping system of the toolholder receptacle.

21. The device according to claim 20, wherein in the toolholder of the first kind the through bores are provided as the recesses which are engaged by the clamping elements.

22. The device according to claim 20, wherein on the toolholder of the first kind, in addition to the through bores, the recesses are provided that are engaged by the clamping elements.

23. The device according to claim 20, wherein the toolholder receptacle has lateral passages, wherein through the lateral passages and through the through bores of the toolholder the clamping system is accessible by means of an actuating tool, wherein the lateral passages are embodied as the damping bores.

24. The device according to claim 20, wherein the toolholder receptacle has lateral passages, wherein through the lateral passages and through the through bores of the toolholder the clamping system is accessible by means of an actuating tool, wherein, in addition to the lateral passages, the damping bores are provided separately in the tool holder receptacle.

25. The device according to claim 20, wherein in the tool holder of the first kind the recesses are designed such that the damping elements, in accordance with an orientation of the damping bores are screwed into the toolholder receptacle at different angles, with a front end thereof are securable in one and the same recess.

26. The device according to claim 20, wherein the axis of the clamping bores is positioned perpendicularly to a tool axis.

27. The device according to claim 20, wherein the axis of the clamping bores, viewed in a screw-in direction of the clamping elements), is positioned relative to a tool axis at an angle smaller than 90° or an angle greater than 90°.

28. The device according to claim 20, wherein in a bottom area of the conical receptacle a follower element for a positive locking engagement with the toolholder is removably arranged.

29. The device according to claim 20, wherein the toolholder receptacle has access bores for clamping screws for a tool which screws are located in the toolholder.

30. The device according to claim 29, wherein the access bores and the clamping bores are substantially positioned on the same axial circumferential circle.

31. The device according to claim 20, wherein in a contact area between the front end of the toolholder receptacle and the toolholder a circumferential slot is provided and an actuating tool with a non-round cross-section is insertable into the circumferential slot for axial relative displacement of the toolholder receptacle and the toolholder relative to one another.

32. The device according to claim 20, wherein the toolholder receptacle comprises an axially adjustable stop screw.

33. The device according to claim 20, wherein at least one of the toolholder and the inner cone of the toolholder receptacle is provided with a radial hollow-ground shape.

34. The device according to claim 20, wherein the cone across the axial length has a round cross-section or a non-round cross-section.

35. The device according to claim 20, wherein the clamping bores are threaded bores and the clamping elements are clamping screws.

36. The device according to claim 35, wherein the clamping screws have a clamping cone at a front end thereof.

37. The device according to claim 35, wherein the clamping screws with their front end load a separate pressure member.

38. The device according to claim 20, wherein the clamping elements are formed as pressure members and the pressure members are arranged on an adjusting element correlated with the toolholder receptacle, wherein through the adjusting element the pressure members are actuatable such that an adjusting movement of the adjusting element moves the pressure members substantially radially in the clamping bores.
